(19) United States
(12) Patent Application Publication
(10) Pub. No.: US 2015/0227972 A1
(43) Pub. Date: Aug. 13, 2015

(54) SYSTEM AND METHODS FOR IDENTIFYING AND PROMOTING TAGGED COMMERCIAL PRODUCTS

(71) Applicant: Huang (Joy) Tang, Chicago, IL (US)

(72) Inventor: Huang (Joy) Tang, Chicago, IL (US)

(21) Appl. No.: 14/615,729

(22) Filed: Feb. 6, 2015

Related U.S. Application Data
(60) Provisional application No. 61/937,103, filed on Feb. 7, 2014.

(51) Int. Cl. G06Q 30/02

(52) U.S. Cl. CPC G06Q 30/0255

(57) ABSTRACT

A system is provided for identifying and promoting tagged commercial products. The system may include a database storing product information for a plurality of commercial products and an interface for receiving submission of a content item containing one or more commercial products. The interface may also allow submission of identification information identifying a product characteristic of at least one of the commercial products in the content item, and the identification information can be stored in the database. A recommendation module may process the identification information and retrieve a subset of product information from the database using product characteristics of the commercial product. A website module generates display logic for displaying the subset of the product information on a user interface for presentation to the user.

### CROSS-REFERENCE TO RELATED APPLICATIONS

The present application claims the priority benefit of U.S. Provisional Patent Application No. 61/937,103, filed Feb. 7, 2014, which is hereby incorporated by reference in its entirety.

### TECHNICAL FIELD

The present description relates generally to systems and methods for identifying and promoting commercial products in an online setting, and more particularly, to an online system for receiving commercial product information via data injection and/or a user interface and for processing the data to identify categories of related commercial products for display and promotion to users of social network.

### BACKGROUND

The evolution and development of electronic technology and data transfer systems allow more users to interact with each other faster and more often. Extraordinary amounts of information and data are shared electronically at a nearly continuous rate. Consequently, online advertising has become a vital source of revenue for enterprises engaged in electronic commerce. Social media marketing and analytics has become a primary contributor to online advertising proceeds. Processes associated with technologies such as Hypertext Markup Language (HTML) and Hypertext Transfer Protocol (HTTP) enable a web page to be configured to display advertisements. However, in addition to advertisements, it is often desirable to find new ways for targeting additional product information and resources on a web page to a particular user or set of users.

While various algorithms are employed to perform data analytics and to produce recommendations, often a user is in a unique position to identify trends and to provide data relating to web content that may not otherwise be obtainable by a web system. Along these lines, users often use social media marketing to create, edit, and share online content with members of the user's social circle. Social networking sites, such as Facebook® and Twitter®, have sought to use feed-driven data in order to generate content feeds that are relevant to a particular user. Websites like Pinterest®, on the other hand, have sought to use behavior-driven data to collect and display object data that may be relevant to a particular user. Each of these divergent approaches has led to the respective sites being valued in the billions of dollars. However, neither of these approaches provides an optimal setting for identifying and promoting commercial products. To that end, it is desirable to provide a system for identifying and promoting commercial products in an online setting that utilizes unique approaches to identify categories of related commercial products for display and promotion to the website's users.

### SUMMARY

In accordance with the systems, products, and methods described herein, a system is provided for identifying and promoting tagged commercial products. The system includes a database storing product information for a plurality of commercial products and an interface module configured to receive submission of a content item containing one or more commercial products and identification information identifying a product characteristic of at least one of the commercial products. The interface module is further configured to store the identification information in the database. A recommendation module is configured process the identification information and to retrieve a subset of product information from the database using at least the product characteristic of the at least one commercial product, and a website module configured to generate display logic for displaying the subset of the product information on a user interface.

Additional systems and methods described herein provide for identifying and recommending tagged commercial products. Commercial product data defining one or more product characteristics of a plurality of commercial products to a database is stored. Submission of a content item and an indication identifying a commercial product contained in the content item are received. The stored commercial product data is processed to generate a plurality of recommended tags describing potential product characteristics of the identified commercial product. A selection is received of at least one of the plurality of recommended tags, the selection signifying an association of the recommended tag and the identified commercial product, and the stored commercial product data is updated with data representing the association of the recommended tag and the identified commercial product.

Additional systems and methods described herein provide for storing commercial product information to a database and providing a user interface that allows a user to upload a content item containing one or more commercial products. An identification of one or more commercial products in the content item is received from the user. The stored commercial product information is processed to update the user interface to dynamically guide the user in defining one or more tags associated with a commercial product contained in the content item, and the stored commercial product information is updated with the defined one or more tags associated with the commercial product.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a network environment in which the system operates according to one embodiment.

FIG. 2 is a block diagram of an exemplary website module of the system according to one embodiment.

FIG. 3 is a block diagram of exemplary component modules that makeup the website module of the system according to one embodiment.

FIG. 4 is a flowchart illustrating an exemplary method for generating a feed of promoted commercial products according to one embodiment.

FIG. 5 is a flowchart illustrating an exemplary method for identifying commercial products and receiving user-defined categories according to one embodiment.

FIG. 6 is a flowchart illustrating an exemplary method for generating and conducting polls according to one embodiment.

FIG. 7 depicts an exemplary graphical representation of a default content feed according to one embodiment.

FIG. 8 depicts an exemplary graphical representation of a user interface for identifying characteristics and categories of commercial products according to one embodiment.

FIGS. 9A-9E depict exemplary graphical representations of a mobile user interface for generating user-defined defining commercial product categories and characteristics according to one embodiment.

FIG. 10 depicts an exemplary graphical representation of a user interface for defining a fashion-based poll according to one embodiment.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. Accordingly, the invention is not to be restricted except in light of the attached claims and their equivalents.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

By way of introduction, communications technologies allow consumers, businesses, advertisers, and other organizations (generally referred to herein as “users”) to rapidly exchange information, data, and ideas. Users may transmit, receive, or otherwise share content items through or using a variety of electronic media, networks, and formats. “Content item,” as used herein, generally refers to web content that may be displayed on a web page and viewed or interacted with by a user. Content items may span a wide range of formats, and may include articles, pictures, videos, social media content, as well as other sources of information that it may be desirable to promote to Internet users.

Various social media websites now provide platforms that allow users to search, find, review, edit, post, and share certain content items with other users within their social network. Other members within a particular user's network, whether it be a limited network of authorized users or an open network, are likewise able to view, edit, and re-post content items that were previously shared by other members in, or even outside of, their respective network. Moreover, third-party websites may display content items side-by-side easily accessible hyperlinks that allow users to quickly share those content items directly on their respective social networks. To facilitate this process, social networking sites may provide application programming interfaces (APIs) that provide access to various social networking data. For example, using various social networking APIs, a content item displayed on a third-party website may be displayed alongside a series of quick-links that allow a user viewing the picture to “like” or share the item on one or more social networking websites directly from the third-party website. In this way, social networking data relating to user interaction with a content item can be generated via APIs accessed from or by third-party websites.

API access to social networking data may also be used to facilitate various processes for determining items that are trending online or items that may have gone “viral.” As content items receive more views, and in turn receive more shares and referrals within various social networks, the content item may reach a point where the content is considered to have gone viral and exponentially increases in user access requests. By monitoring varying levels of virality, or items that are “trending,” combined with other data analytics techniques, a system can be designed to identify content items that are most likely to have promotional value when served to a particular user.

Additionally, social networking data can be aggregated, and in some instances, displayed alongside a content item when the content is displayed on a third-party webpage. For example, an article on ESPN.com may be displayed alongside a number of social networking referral indicators showing how many times the article has been shared and/or liked on various social networking sites. As used herein, “referral indicator” is intended to encompass all forms of social networking data that may be available via social network APIs and which may be used to indicate that users have interacted with content using a social network. For example, referral indicators may be indicative of a number of shares or “likes” on Facebook®, a number of “tweets” or “retweets” on Twitter®, a number of “pins” on Pinterest®, or based on hash tag popularity across multiple social networks. Additionally, referral indicators may consist of indicators relating to internal product promotion data within a particular website domain, such as numbers or symbols indicating activity on group forums or user interactions from within the domain website itself. Thus, referral indicator is intended to broadly encompass all types of indicators that may be used to gauge the level of social interaction with Internet content items. A person having skill in the art would recognize that additional techniques for indicating referrals and product performance on websites, such as social networks, may be developed and used with the scope and spirit of the description.

Given the growth and importance of ecommerce as a revenue generator for both online advertising and commercial product sales, manufacturers may benefit from using aspects of social networking to promote their commercial products. In particular, manufactures may benefit from having their commercial products associated with high quality descriptive data and tags, such as descriptive data that may be created or defined by one or more users of a social network themselves. Additionally, manufacturers may benefit from an improved social website or forum that allows social network users to assist in identifying and tagging commercial products with descriptive data in order to promote those products to other social network users. In addition to benefits to manufacturers, advertisers may also benefit from associating their advertisements with content items that have increased consumer appeal, such as may be indicated by aggregating social networking referral indicators and analyzing historical performance data for content items on the site.

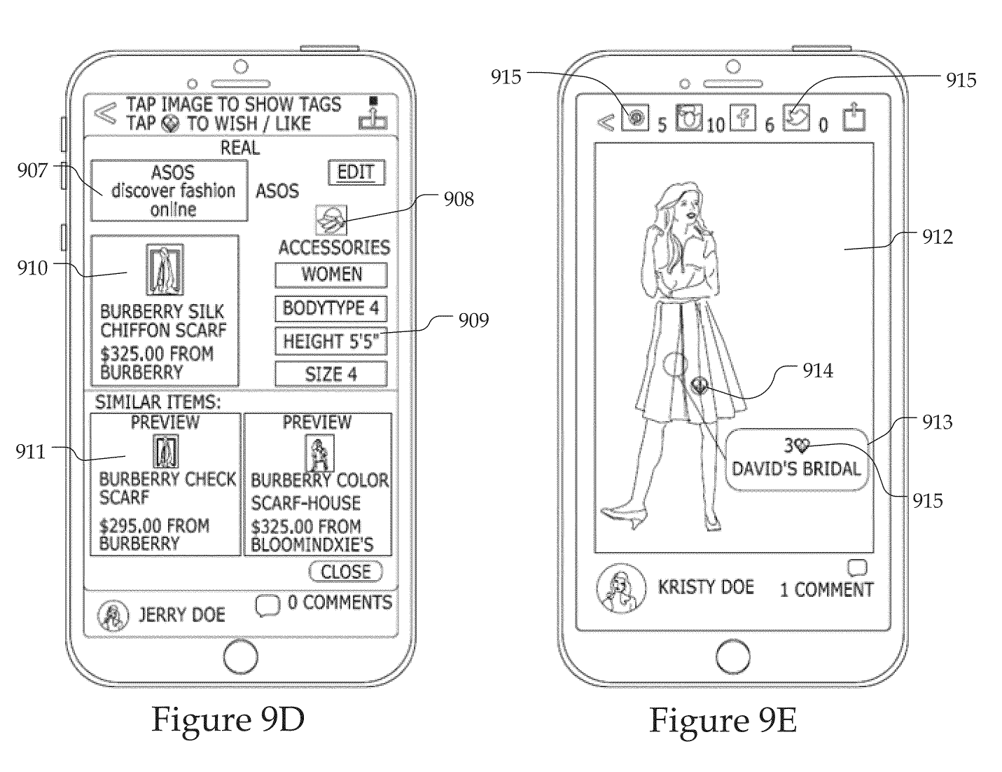

The present description is directed to allowing users, including consumers, manufacturers, and advertisers, to identify and promote commercial products in an online system. In one aspect, a back-end system and database is provided to store and maintain data relating to commercial products and is coupled a website or domain interface. Users may utilize the domain interface associated with the website to identify one or more commercial products that have been uploaded as part of a content item or linked to on the website, such as in pictures. The user may then tag the commercial products with information related to, for example, product characteristics, styles, brand names, manufacturer information, retail price, suggested uses, and/or other categories. For example, a user may upload a picture to the website, or grant the system access to scan one or more photos located on the user's computer or on a social networking account. The user interface can then prompt the user to identify or tag the image, or a sub-portion thereof, in order to identify a commercial product shown within the image. In one embodiment, an interface can be provided that allows the user to draw a box or other shape around a commercial product in the photograph. In other embodiments, the interface may allow the user to add destination leader lines to pinpoint product location on photo and associate the pinpoint with a connection to tags that placed on top of photo, as illustrated in FIG. 9E for example. Alternatively, the system may “auto-recognize” the commercial product in order to generate a “bounded” outline of the product within the photograph. The generated bounded outline may optionally be edited or refined by user input.

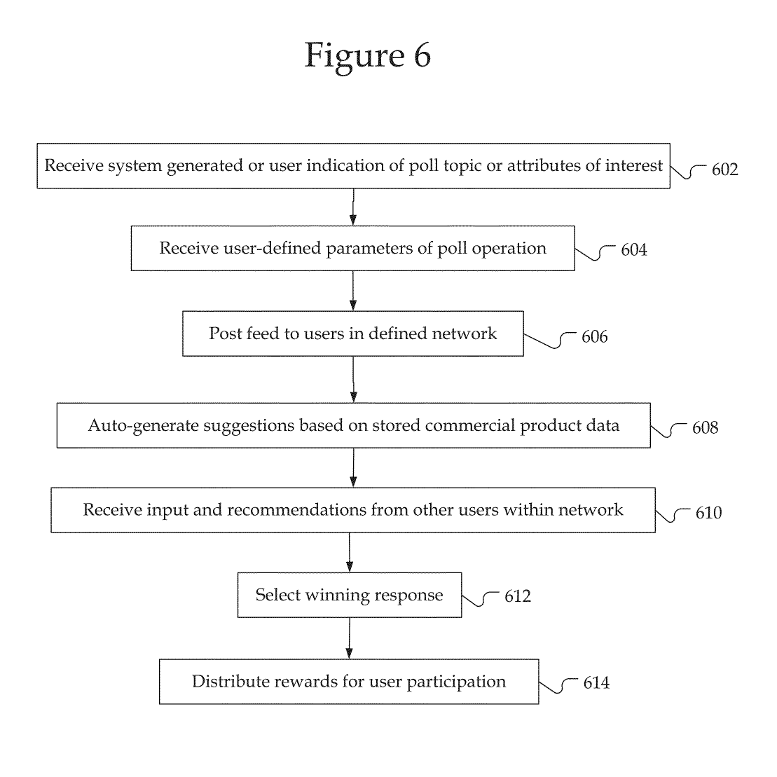

Once a user has identified a commercial product in a photograph, the user is then prompted to identify one or more characteristics of the product, as described in further detail in connection with FIG. 5. The system may also provide rewards or incentives encouraging the user to provide multiple, high quality tags. By providing high-quality, user-defined tags the system is able to generate additional data that can be used to promote other commercial products on one or more social networks. The data may be used to promote products on the website itself or may be selectively packaged and sold to one or more third-party manufacturers or advertisers. In certain embodiments, the user may be required to enter a mandatory or preferred category, such as brand name or manufacturer of the product, in order to receive a reward credit for the action. Various reward schemes are contemplated in accordance with present description and may be implemented to provide users with incentives for defining high-quality product tags, as well as participating in social networking features provided by the website. A similar process may be used to allow a user to define tags and data for other forms of content items in addition to photographs. For example, in the case of videos, the user may not only associate product information to the video, but also include time-sensitive tags identifying a period of the video that the product is displayed.

The website interface may also provide the user with the option of sharing the content items with other users of the site. In this way, the system may operate as its own social networking website in which a user's personal network of friends, family colleagues, coworkers, and the subsequent connections within those networks, can be utilized to find additional relevant connections. An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called “virtual persons.” An individual's social network may be represented in a variety of forms, such as visually, electronically or functionally. For example, for data analytics purposes, a “social graph” or “socio-gram” may represent an entity in a social network as a node and a relationship as an edge or a link. The system may then use degrees of connection in the social network to improve behavioral targeting.

Additionally, the website interface may allow users to link their account with one or more third-party social networking sites through the use of APIs. When a user opts to share a photograph or other web content with users of the website itself, the user may also optionally choose to have the content shared among its third-party social networking sites as well. Referral indicators from these third-party social networking sites can then be monitored and used in accordance with other aspects of the present description.

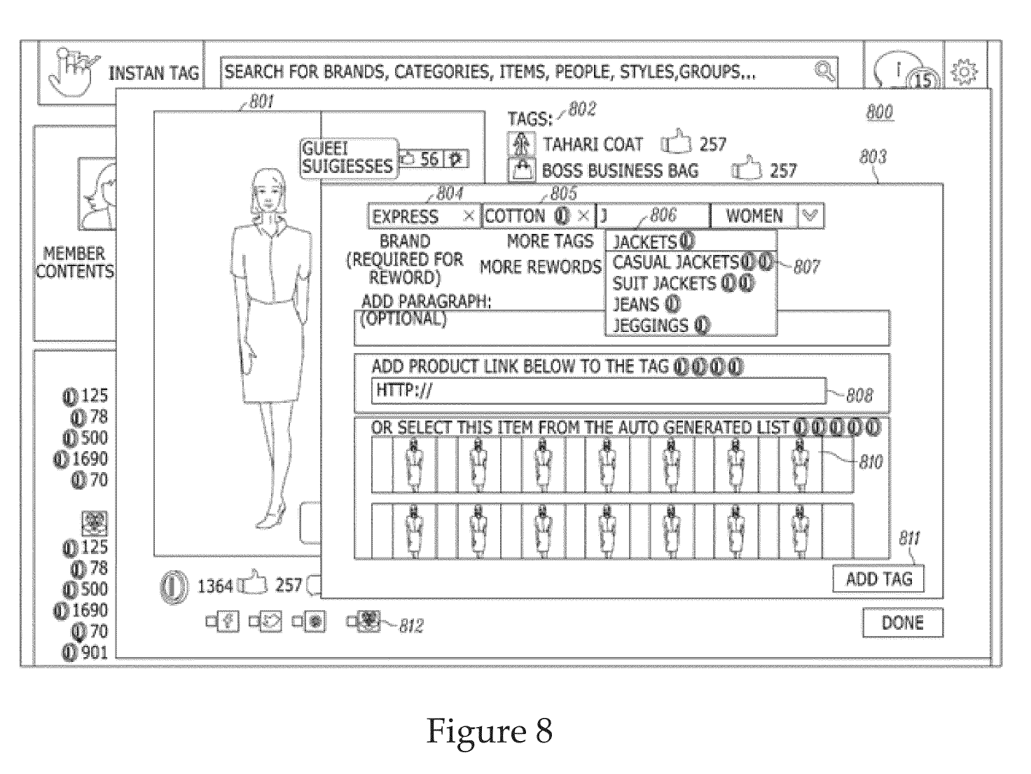

Once a user has uploaded, tagged, and shared a content item on the website, other members may then access, view, and interact with the content item. Various interactions and website features are envisioned in accordance with the present description and are not intended to be limited by the examples provided herein. In one embodiment, a feed of commercial products are displayed to a user when the user logs onto the website. The initial feed may be generated in a number of ways, including based on the user's preferences, the user's historical interactions with the website, trending items on the website, or any number of different filtering criteria which the user or website administrators may have specified. Thus, in certain embodiments, such as depicted in FIG. 7, a user may be initially provided with a splash screen upon logging into their account that includes a “Default Feed” tab 701 of content items posted within the user's social network and/or a “Top Rated” feed of trending items throughout the website domain, which may be included as a separate tab 702 on the initial splash screen. Additionally, the user may define one or more additional feeds that may be displayed alongside the Default and Top Rated feeds, for example by using an add new feed tab 704. The user can define new feeds using an assortment of criteria, including search term keywords, product characteristics, categories, topics of interest, polls, etc. Once a new feed is created, the feed may be saved and updated each time the user logs in, at predetermined intervals, or in real-time as the user interacts with the site.

In some embodiments, the system may collect data feeds by one or more third parties, such as brand manufacturers, product manufacturers, and the like. The system may automatically display a data feed of the content items published by the third-party to users of the system and may update the users' displays in real-time such that users may interact with the displayed content items and add tag information directly to the content items published by third-parties. In additional embodiments, the system may connect directly with third-party affiliate programs to allow the third-party affiliate's products to be displayed directly on the system.

Once an initial feed of content items has been displayed to a particular, that user may engage in a number of interactions with the individual content items in the feed, including, for example, clicking on the item, saving the item, sharing the item on the user's personal feed or on one or more third-party social networks, adding the item to one or more libraries, adding a referral indicator to the content item as a whole or any one of a multitude of individual commercial products that may be tagged within the single content item, and so forth. When a user within the network clicks on a tagged photograph displayed in their feed, whether by clicking the content posted on their own interface of the website or by clicking the content item that may be posted on to a third-party website via the publically accessible APIs provided by the website, the user may be redirected to a webpage displaying a variety of other content items that share descriptive characteristics or categories with the clicked commercial product.

The particular items that are displayed may be determined in a number of ways, such as by selecting content items that share one or more user-defined characteristics with the user's behavioral data, content items that are determined to be trending, content items with significant referral indicator data, or other techniques that use any combination thereof. Additionally, such processes may be optimized based on other aspects of social promotion data and analytics, such as processes that consider the number of likes, shares, and views of the item, or by considering the degree of relationship between the user and other members of the social network have interacted with a particular item. In certain embodiments, trending content items may be receive preferential placement, such as being displayed at or near the beginning of a product list, or receive accented product placement. Additionally, advertisers or manufacturers may pay fees in order to have their commercial products receive preferential display and placement, and/or associations with other competing commercial products.

In some embodiments, once a list of commercial products or content items have been selected and displayed, the user may select any of the content items and perform various actions. For example, a link may be embedded in the displayed content item, or positioned in close proximity to the content item, that allows the user to be redirected to the product page of the particular manufacturer or retailer of the content item. In this way, the website may facilitate user referrals to third-party manufacturer websites where the user can complete a purchase transaction of the item. In certain embodiments, the user may be able to complete a purchase transaction from within a webpage displayed within the domain website of the social network itself. In other embodiments, the user may complete the purchase or check-out on the brand manufacturer's website, but the brand manufacturer may also provide the ability to post a picture of the purchased item on the domain website of the current system. In this way, it may also be beneficial for the brand manufacturer to provide an incentive to the user for posting a summary of the purchase, such as to facilitate additional purchases by the other users that are connected with the purchasing user. The brand manufacturer, for example, may provide incentives for each purchase or conversion that the user's posting resulted in, or may provide incentives for impressions. In either scenario, the website itself and/or third-party manufacturer may provide rewards or monetary incentives to users for promoting their commercial products or otherwise identifying commercial products with high-quality tags or descriptors when those actions lead to a completed transaction or page view.

Additionally, a manufacturer or retailer may opt to manage its own account with the website, in which they maintain a profile and list of products or services for sale. In this way, users of the website may interface directly with the manufacturer or retailer's page in order to share and promote that retailer's products within the user's social network. For example, a local retailer or professional stylist may maintain a page of products or services that are available to a particular set of users, such as those within a geographic range, or to users of the website as a whole. The manufacturer or retailer may benefit from using the reward schemes implemented by the website itself, or the manufacturer may provide its own rewards directly to the user when the user's actions result in a completed transaction.

The website may also provide various services to the manufacturer or retailer, such as by using the website's aggregated data to assist retailers in maintaining updating inventory lists and providing feedback on trending items. In this way, retailers can receive the benefit of informed inventory management using the data analytics implemented in accordance with other aspects of the website described herein. The website may charge the manufacturer or retailer a fee for maintaining an account on the website, or may provide varying levels of access to website features based on a subscription status of the manufacturer or retailer. The website may also provide manufacturers or retailers with ability to control the user-defined tags associated with their product. For example, the products uploaded by manufacturers may be set as protected, and the manufacturer may have the option of approving tags entered by users or removing tags that do not accurately reflect the product image. In some embodiments, the website may allow the brand manufacturer to post items directly to the website without requiring users to utilize a search engine to locate the item. The website may utilize a commission or similar fee arrangement in exchange for providing access to brand manufacturers to post content items having tagged data. Similarly, the brand manufacturer may allow users completing purchases on the brand manufacturer's website to post summaries or photographs of items purchased on the brand manufacturers to the website and may provide the users incentives for doing so. A person having skill in the art would recognize that additional features, or various combinations or modifications to the aforementioned features, may be used within the scope and spirit of the present description.

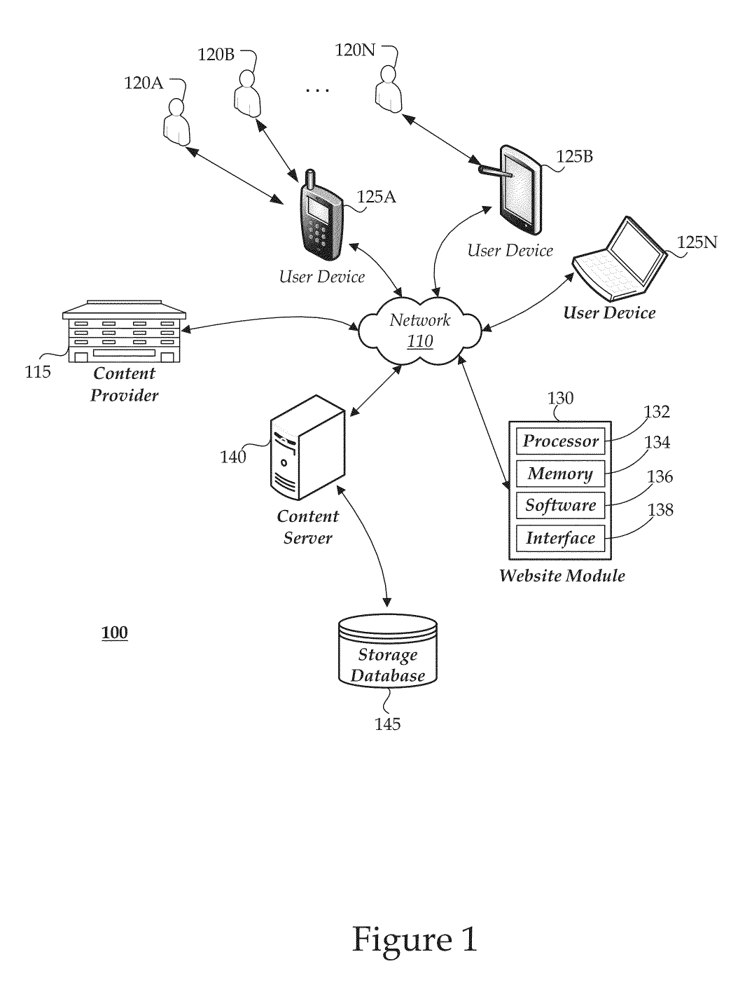

Referring now to the figures, FIG. 1 depicts a schematic diagram illustrating an example embodiment of a simplified network environment 100 for allowing system users to identify and promote commercial products in online content items, such as photographs. Other embodiments that may vary, for example, in terms of arrangement or in terms of type of components, are also intended to be included within claimed subject matter. The network environment 100 may include a variety of communication networks 110, such as the Internet, a local area local area network (LAN), wide area network (WAN), a wireless network, and the like.

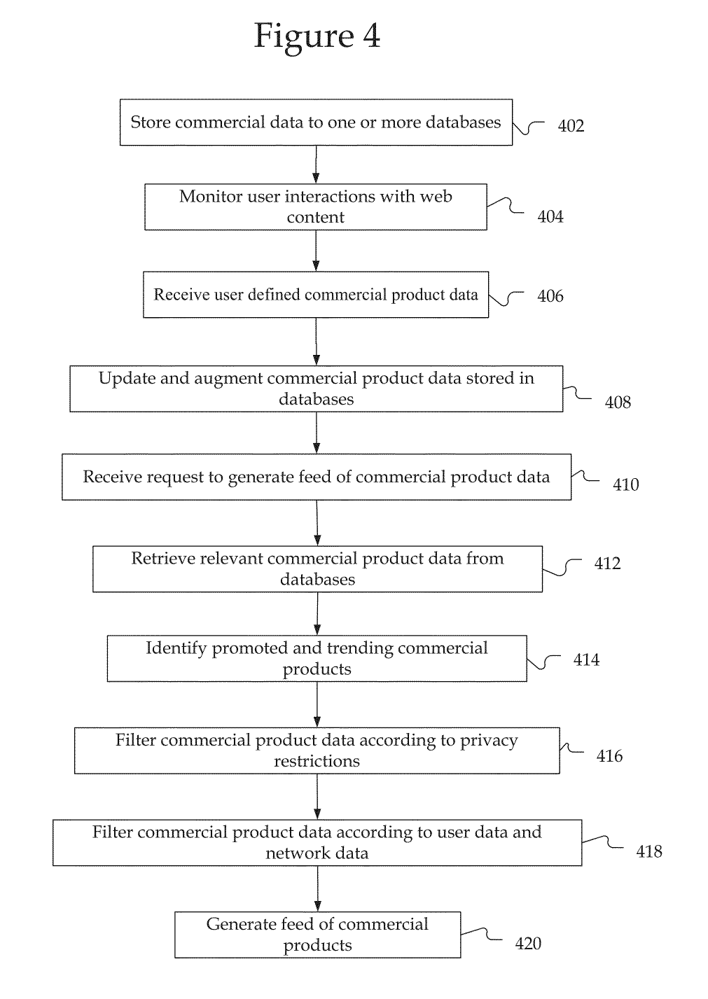

The network environment 100 may include one or more content providers 115. Content providers 115 may generate, create, provide, and/or sponsor content, such as web pages, websites, information, data, or other content items to one or more users 120A-120N, some of whom may access the network 110 using mobile devices 125A-N, such as smart phones, tables, PDA's (personal digital assistants), or other wireless devices. Examples of content may include text, images, audio, video, or the like, which may be processed in the form of physical signals, such as electrical signals, for example, or may be stored in memory, as physical states, for example. A website module 130 may be operatively coupled to the network 110 and be configured to generate a variety of webpages implementing the functionality of the present description. Additionally, website module 130 may consist of, or otherwise make use of, a multitude of individual modules, such as those described in connection with FIG. 3.

The users 120A-120N coupled to the network 110 may interact with the content items provided by content provider 115, which may be the instant social networking website itself, or a third-party provider of content. Users 120A-120N may be people, businesses, machines, content providers 115 themselves, the website module 130, or entities and applications, which may connect and interact with each other through the network 110. Users 120A-120N may connect with content providers 115 and/or other users over the network 110 using one or more of a web application, a standalone application, a mobile application, or mobile client device. Each of the web applications, standalone applications, and mobile applications may individually be referred to as a client application or client device, or a user application or user device. Preferably, the mobile applications or mobile user device 125A-125N is contacted by or communicates with the website module 130. User devices 125A-125N may include a computing device capable of sending or receiving signals, such as via a wired or a wireless network (e.g. the network 110, which may be the Internet). The user devices 125A-125N may, for example, include a desktop computer or a portable device, such as a cellular telephone, a smart phone, a display pager, a radio frequency (RF) device, an infrared (IR) device, a PDA, a handheld computer, a tablet computer, a laptop computer, a set top box, a wearable computer, an integrated device combining various features, such as features of the foregoing devices, or the like. The user devices 125A-125N may vary in terms of capabilities or features, particularly with regard to display size and aspect ratio. The different display sizes and aspect ratios for different user devices may result in a web page or advertisement being rendered differently for those particular user devices. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The user devices 125A-125N may include or may execute a variety of operating systems, including a personal computer operating system, such as a WINDOWS®, MAC OS X®, UNIX®, IOS®, or LINUX®, or a mobile operating system, such as IOS®, ANDROID®, or WINDOWS MOBILE®, or the like. The user devices 125A-125N may also include or may execute a variety of applications, such as a client software applications enabling communication with other devices, such as communicating one or more messages, such as via email, short message service (SMS), or multimedia message service (MMS), including via a network, such as a social network, including, for example, FACEBOOK®, LINKEDIN®, TWITTER®, FLICKR®, or GOOGLE+®, to provide only a few possible examples. The user devices 125A-125N may also include or execute an application to communicate content, such as, for example, textual content, multimedia content, or the like. The user devices 125A-125N may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities.

Not all of the depicted components in FIG. 1 may be in every system, however, and some implementations may include additional components not shown in the figures. Variations in the arrangement and type of the components may be made without departing from the spirit or scope of the claims as set forth herein.

A content server 140 may include a device that is configured to provide content via a network to another device. A content server may, for example, host a site, such as a social networking site, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content items hosted by content servers may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

The website module 130 may communicate with a back-end system in order to generate logic to display a user interface for identifying and promoting commercial products, including providing an interactive user interface for navigating various domain features in accordance with the present description. Website module 130 may comprise one or more individual modules located and operated from a single server or may consist of multiple modules spread across multiple, distributed servers in operative communication with each other. Website module 130 may be further configured to generate a multitude of webpages with a variety of interactive elements that allow a user to login into the domain, verify user identify, and to interact with and organize data relating to, for example, commercial products. In addition, while the preferred embodiment of the present descript relates to identifying and promotion commercial products (e.g., clothing and fashion items), such as those which may be located in photographs and tagged with descriptive information, one having skill in the art would recognize that the system may be readily adapted to apply to other contexts as well. Such other contexts could include, as non-limiting examples, food, health and beauty, home décor, electronics, automobiles, traveling or vacation destinations, and so forth.

The website module 130 may be a computing device capable of generating a graphic display page with a plurality of elements and for monitoring user interaction with those elements and the page. The website module 130 may include a processor 132, memory 134, software 136 and an interface 138. The website module 130 may be a separate component from the content server 140, or the system may be combined as a single component or device. Additionally, one or more of the components of website module 130 may be hosted on a single computing device or may be distributed among one or more distributed computing devices in operative communication, such as distributed servers connected over network 110.

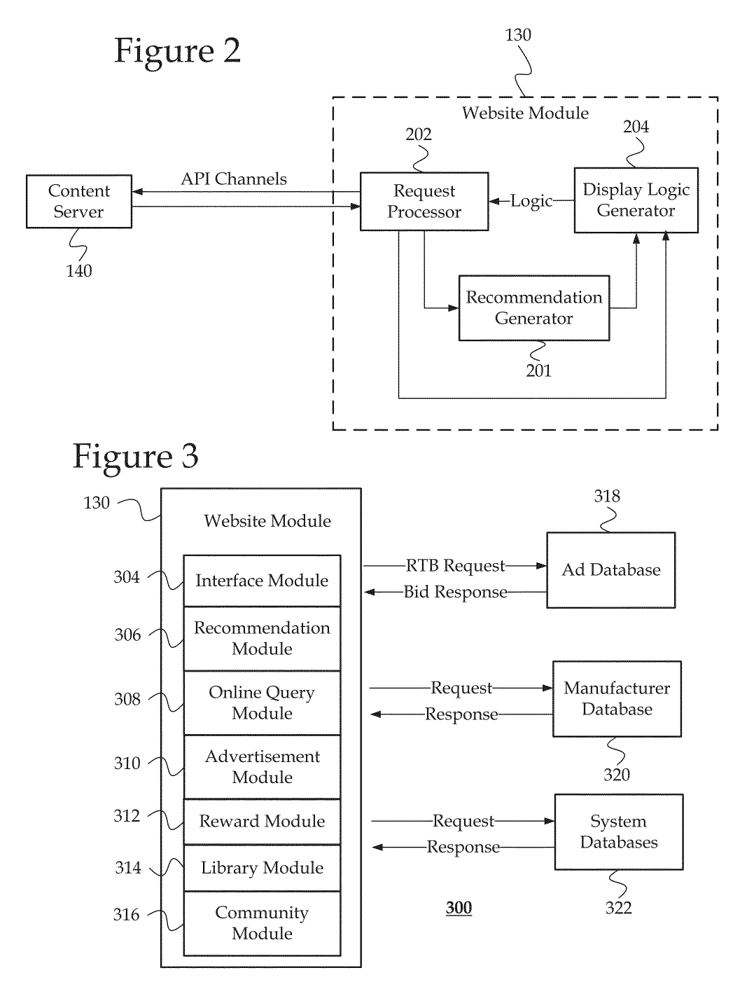

The interface 139 may communicate with any of the user device 125A-125N, the content server 140, and/or the content provider 115. The interface 138 may include a user interface configured to allow a user and/or administrator to interact with any of the components of the website module 130. For example, the users 120A-120N and/or administrator may be able to interact with a content item page and, through their interactions, cause display logic to be generated by website module 130, as discussed in connection with FIG. 2, to display information related to one or more commercial products.

The processor 132 in the website module 130 may include a central processing unit (CPU), a graphics processing unit (GPU), a digital signal processor (DSP) or other type of processing devices. The processor 132 may be a component in any one of a variety of systems. For example, the processor 132 may be part of a standard personal computer or a workstation. The processor 132 may be one or more general processors, digital signal processors, application specific integrated circuits, field programmable gate arrays, servers, networks, digital circuits, analog circuits, combinations thereof, or other now known or later developed devices for analyzing and processing data. The processor 132 may operate in conjunction with a software program, such as code generated manually (i.e., programmed).

The processor 132 may be coupled with a memory 134, or the memory 134 may be a separate component. The interface 138 and/or the software 136 may be stored in the memory 134. The memory 134 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 134 may include a random access memory for the processor 132. Alternatively, the memory 134 may be separate from the processor 132, such as a cache memory of a processor, the system memory, or other memory. The memory 134 may be an external storage device or database for storing recorded ad or user data. Examples include a hard drive, compact disc (CD), digital video disc (DVD), memory card, memory stick, floppy disc, universal serial bus (USB) memory device, or any other device operative to store ad or user data. The memory 134 is operable to store instructions executable by the processor 132. Additionally, website module 130 may be in operative communication with one or more databases, distributed or otherwise, which aggregate and store information related to commercial products.

The functions, acts or tasks illustrated in the figures or described herein may be performed by the programmed processor executing the instructions stored in the memory 134. The functions, acts, or tasks are independent of the particular type of instruction set, storage media, processor or processing strategy and may be performed by software, hardware, integrated circuits, firm-ware, micro-code, and the like, operating alone or in combination. Likewise, processing strategies may include multiprocessing, multitasking, parallel processing and the like. The processor 132 is configured to execute the software 136. The software 136 may include instructions for generating a product page with a plurality of elements and for monitoring user interaction with that page and the elements.

The interface 138 may be a user input device or a display. The interface 138 may include a keyboard, keypad or a cursor control device, such as a mouse, or a joystick, touch screen display, remote control or any other device operative to interact with the website module 130. The interface 138 may include a display coupled with the processor 132 and configured to display an output from the processor 132. The display may be a LCD, an organic light emitting diode (OLED), a flat panel display, a solid state display, a cathode ray tube (CRT), a projector, a printer or other now known or later developed display device for outputting determined information. The display may act as an interface for the user to see the functioning of the processor 132, or as an interface with the software 136 for providing input parameters.

The present disclosure contemplates a computer-readable medium that includes instructions or receives and executes instructions responsive to a propagated signal, so that a device connected to a network can communicate voice, video, audio, images or any other data over a network. The interface 138 may be used to provide the instructions over the network via a communication port. The communication port may be created in software or may be a physical connection in hardware. The communication port may be configured to connect with a network, external media, display, or any other components in network system 100, or combinations thereof. The connection with the network may be a physical connection, such as a wired Ethernet connection or may be established wirelessly as discussed below. Likewise, the connections with other components of the network system 100 may be physical connections or may be established wirelessly. Any of the components in the network system 100 may be coupled with one another through a network, including but not limited to the network 110. For example, the website module 130 may be coupled with the content server 140 and/or the content provider 115 through a network 110. Accordingly, any of the components in the network system 100 may include communication ports configured to connect with a network, such as the network 110, which may be a wireless network.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

The network connecting the devices described above (e.g., the network 110) may be a “content delivery network” or a “content distribution network” (CDN). For example, the content provider 115 and/or the content server 140 may be part of a CDN. A CDN generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Likewise, the network connecting the devices described above (e.g. the network 110) may be a peer-to-peer (or P2P) network that may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.” For example, the content provider 115 and/or content server 140, or one or more servers not illustrated, may provide advertisements and/or content to the user devices 125A-125N over a P2P network, such as the network 110. User devices 125A-125N may access content from content provider 115, content server 140, or interface 138 via a mobile application interface, such as a smartphone application that may be implemented on ANDROID®, IOS®, or similar smartphone platforms.

Referring now to FIG. 2, FIG. 2 depicts a block diagram of an exemplary website module 130. The website module 130 may include a request processor 202, which may be the same as the processor 132 discussed in connection with FIG. 1. The website module 130 may further include a display logic generator 204 and/or a recommendation generator 201. The content server 140 may provide the website module 130 with access to content items such that the website module 130 may monitor and receive information relating to commercial products. During operation, the request processor 202 receives data regarding a variety of content items from content server 140 in order to generate display logic relating to the performance or level of user interaction with a set of content items. For example, request processor 202 may communication various content servers 140, such as social networking servers, through publically available API channels. Request processor 202 can retrieve data relating to referral indicators and other performance data for various content items. Additionally, the website module 130 may provide its own set of APIs that allow content server 140 to communicate with one or more databases associated with website module 130 and website interface. In this way, a user accessing content items on content server 140 can quickly share and save information to their user account on the domain website directly from the content server 140. The request processor 202 may analyze user interactions with the content item, either on the content server 140 or via the user interface 138, to ultimately update and maintain system databases that aggregate data relating to a variety of commercial products. The display logic generator 204 may then generate logic used to create graphical representations displaying the data relating to the commercial products, such as in a feed to the user interacting with user interface 138.

In certain embodiment, the website module 130 may use the recommendation generator 201 to retrieve and process category or other descriptive information associated with the content item received from content server 140 or stored in a system database accessible by the website module 130. The display logic generator 204 may then use the recommendation generator 201 to generate and display content that is relevant to a user's interaction with the interface 138. For example, a user may enter a search query into a search bar on the user interface 138. Request processor 202 will receive the query and process it using recommendation generator 201. Recommendation generator 201 will communicate with one or more databases, or with content server 140 via network 110, and generate a list of associated commercial products as well as any descriptive information that may be stored by the system for those products. Display logic generator 204 may then generate interactive elements that may be displayed to the user via interface 138. Additionally, if a user interacts by clicking on a displayed content item, such as on interface 138, request processor 202 may follow a similar process in order to generate graphical elements displaying similar content items, such as those that share one or more descriptive characteristics with the displayed content item. Request processor 202 and display logic generator 204 may handle a variety of requests associated with the use of website module 130, and may or may not need to make use of recommendation generator 201 to process stored product data using, for example, performance data, user preferences, historical data, and various data analytics techniques in order to produce recommendations to display to a particular user.

Using a similar process, recommendation generator 201 may be further utilized to provide user-specific recommendations based on one or more qualities or traits associated with the user and/or with content items uploaded by the user. For example, recommendation generator 201 may utilize one or more artificially intelligent algorithms to determine the user's body type and produce recommendations that are tailored to the user's body or other traits about the user's physical attributes that may be determined by the system. Recommendation generator 201 may also utilize one or more artificially intelligent algorithms to determine one or more attributes associated with the user's preferred style or interests. In these instances, recommendation generate 201 produce product recommendations or display content items that are determined share similar characteristics with the user's body type, styles, and interest as may be determined through analysis of the user's interactions with the website or by an explicit user-selection.

Referring now to FIG. 3, a website module 130 according to one embodiment is depicted in further detail. In this embodiment, website module 130 may comprise one or more individual modules. Each of the individual modules may be stored on the same computing device or distributed among one or more computing devices. In one embodiment, web module 130 may consist of interface module 304, recommendation module 306, online query module 308, advertisement module 310, reward module 312, library module 314, and community module 316. In other embodiments, website module 130 may include additional components or modules not illustrated in the figures, or alternatively, may not include in all of the modules depicted. Thus, variations in the arrangement and type of the components may be made without departing from the spirit or scope of the claims as set forth herein.

Website module 130 may also communicate with one or more databases. In one embodiment, website module 130 can communicate with ad database 318, manufacturer database 320, and/or one or more system databases 322. Each of these databases may be maintained by the same operator of the present system, or may be maintained and operated by a third-party. In one embodiment, advertisers may wish to associate advertisements with various commercial product information displayed by website module 130. Website module may communicate with ad database 318 in order to engage in real-time bid (RTB) requests and responses. In other embodiments, manufacturers may use one or more features provided by website module 130 in order to create and maintain their own manufacturer presence on the website. Additionally, website module 130 may access the manufacturer database to retrieve product information and details related to various commercial products displayed by website module 130. The system itself also maintains one or more system databases 322 for aggregating data relating to user interactions with the website module 130, content server 140, and/or any content item hosted by either the content server 140 or the system itself.

Referring now to the various modules that may be provided with the system, website module 130 utilizes one or more of its component modules to generate webpage data for output to a web browser and display via interface module 304. In some implementations, a portion of the webpage data is stored locally and retrievable by interface module 304 from previous webpage data transfers and, therefore, an updated portion of webpage data is sent to complement or overwrite the webpage data already stored on the interface module 304. Generally, at least a portion of the webpage data is generated in response to a user request or interaction with the interface module 304. For instance, the webpage data may be customized to a particular user and/or time period before being output by the website module 130.

The recommendation module 306 communicates with one or more of the system and/or manufacturer databases to retrieve information related to commercial products to be displayed. Recommendation module 306 may process stored commercial product data to predict which commercial product data is most relevant in response to the user interaction. In certain embodiments, the recommendation module 306 may consider click through data, user preferences, historical data, interaction data, and/or other types of performance data, to predict which items best match the user's request and/or which items are most likely to lead to further user interaction, such as completed sales. For example, when used with content items relating to articles of clothing, the recommendation module 306 may process stored product data to predict fashion trends based on user interactions with product data displayed via interface module 304. This data may be then used by the system to determine which items should be displayed to other users of the system, or may be sold to manufacturers and retailers as indications of which items have gained popularity, and should, for example, be displayed in online and offline retail shops.

Recommendation module 306 may also make use of various algorithms, machine learning techniques, and data analytics for predicting the trendworthiness. For example, recommendation module 306 may use historical and performance data relating to exponential time decay, weighted data relating to product popular, and/or frequency of the recurrence of descriptive keywords associated with a particular content item in order to predict which items are trending in the various networking communities. Various data analytic techniques may further be used to process performance data and may utilize one or more machine learning approaches to further enhance the quality of stored commercial product data, such as by improving designated associations between content items and their associated attributes or descriptive characteristics. In this way, the system may constantly monitor and update data associated with each content item in order to optimize the relationships between products and their tagged data, such as intermittently or in a real-time fashion. Additionally, recommendation module 306 may consider aspects of social computing, such as time components, degrees of connections between related users, and/or frequency of descriptive keywords within a particular network. Further recommendation module may consider aggregated data retrieved from one or more third party sources, such as hash tag data from other social networking sites. In this way, the system can retrieve highly personalized data particular to an individual user based on that user's social network interactions, such as by considering keywords submitted by users sharing a close degree of friendship, or may also retrieve and analyze data to predict trends in the network-at-large, or some subset thereof.

Interface module 304 may also allow a user to enter a search or query term. In this instance, online query module 308 will receive and process the query term and communicate with one or more other databases or modules, such as recommendation module 306, to produce a list of results related to the users query. Additionally, advertisement module 310 may receive query information from online query module 308 and communicate with one or more ad databases 318 to retrieve advertisements relevant to the user's query. Advertisement module 310 may also analyze the elements displayed by the interface module 304 to select one or more relevant advertisements for display on the user interface based on the other displayed elements by interface module 304. In this way, the system can utilize advertisement module 310 to generate advertising revenue by, for example, associating related commercial products with the products that are already being displayed on the user interface. For example, a user may upload and tag a picture of one brand of clothing with descriptive characteristics, or the user may grant the system access to scan one or more photos located on the user's computer or on a social networking account. The tagged photograph may then be displayed to subsequent users of the site when making product recommendations to those users. Competitors of the manufacturer of the product in the displayed in the tagged photograph may also wish to pay a fee to have their advertisement displayed when a particular competing product or brand is displayed to users. Various advertising schemes for monetizing product data and displaying advertisements may be used within the scope and spirit of the description.

A rewards module 312 may be utilized to provide incentives for user participation in various aspects of the system, such as defining tags or creating polls. A rewards program can be designed and associated with each user account. The rewards may be real-money based, or may implement virtual currency or points-based reward schemes. In particular, it is beneficial to provide a reward scheme that incentivizes users to both participate in the system itself, but also to provide high-quality data to the system. For example, when a user uploads a content item to the website or grants the system access to scan one or more photographs, the user is asked to define one or more categories or product characteristics associated with that content item. Various reward schemes are used to incentivize the user to provide high-quality categories and descriptive product characteristics. In this way, the system helps ensure that the data received from various users is both accurate and relevant. Once a user has uploaded content to the website, the user may receive additional rewards based on the number of likes, or other referral indicators, that the item receives either on the website itself or on any social networking site that the user has linked to the user's account. The use may then be able to turn in accumulated reward points in exchange for, for example, discounts on merchandise, to buy gift merchandise for friends, and the like. Additionally, the system utilize deep links for each item tagged using the system such that the system may track user interactions with the content item on related websites, such as other social media websites. In this way, the system can provide incentives whenever other users interact with the content item on other websites, such as when a tagged content item is shared on a related social media website.

In additional embodiments, a level-based reward scheme may be used. Users may use the website features and post product information in order to gain experience and to reach the next level. The number of times that a user may post items, or the type of actions the user may take, may be restricted by that particular user's level. Optionally, a user may pay to lift certain restrictions, or pay to gain a certain level of access to website features. A user's particular level may also be used to limit the extent to which the user's posts are displayed to other users of the website (i.e., the post's exposure). Various contests may also be used as incentives for users to participate in and generate high-quality product information. For example, contest may be set up that instructs users to generate the best response to a particular question or goal, such as designing the best outfit for a particular purpose. Users may then respond to that contest in hopes of gaining rewards, and in doing so generate high-quality data directed to a specific topic that was the focus of the contest. Various types of contests can be used to generate rewards for the participating users and to generate data for a particular topic.

Additionally, surveys or polls may be provided in conjunction with the reward module 312. Surveys can be used as a way to receive direct consumer feedback on topics that may be of interest to a user, manufacturer, retailer, or advertiser. The rewards module 312 may provide rewards in order to incentivize consumers to participate in and to complete the surveys. Additionally, third-party manufacturers, retailers, and/or advertisers may provide their own rewards to the user, such as real money rewards or discounts for commercial products. In this way, the website may facilitate a way for manufacturers and advertisers to reach consumers with a focused interest in a particular commercial product.

Library module 314 may also be provided where a user can save a collection of one or more content items that have been viewed on or uploaded to the website. All or some of the content items that the user has saved may be displayed and accessible along with their associated commercial product data. The user may sort the displayed content, such as by defining one or more sub-categories or groupings of content items that can be accessed at a later time by the user and/or other members within their social network. For example, the user may create one or more albums of photographs of commercial products that are organized by topic, category, and/or descriptive characteristic (e.g., casual, cocktail attire, business, cotton, silk, short-sleeve, sleeveless, dress, pant, or other similar properties and considerations that may be relevant to the particular nature of the content item). The user may then save additional content items to their respective albums while viewing and interacting with website content. Additionally, the user may specify privacy restrictions for items uploaded by the user or saved by the user on a global or per album basis.

In certain embodiments, an additional library feature may be provided where all content items uploaded or tagged by the user are stored and displayed in a separate display window. The user may access this window to track the performance data of the content items and data created by the user. The user may be able to not only view and access all of their previous uploaded content, but can also track view performance data related to their individual items, as well as organize that data by various constraints. For example, in one embodiment, the back-end system and database and may monitor and store information related to users interaction with web content. This data may be displayed alongside or in connection with content items displayed as part of a particular user's library. Various methods of interaction can be provided to the user in order to allow the user to, for example, sort the data by number of referral indicators, date or recency, and other similar constraints.

Community module 316 may also provide a variety of social interaction features to users of the website. In certain embodiments, community module 316 allows users to create and participate in groups, events, and/or forums (generally referred to herein as “groups”). Users of the website may access various groups in accordance with any privacy restrictions as may have been set by the creators. Community module 316 allows users to create groups that may, for example, be directed to a particular topic or subset of commercial products. When users create or upload new content items, the interface module 304 may communicate with community module 316 in order to display a list of particular groups that the particular user has access rights to. The user can then select which groups the user would like the content item to be displayed in or associated with, such as by clicking boxes related to one or more events, groups, or forums.

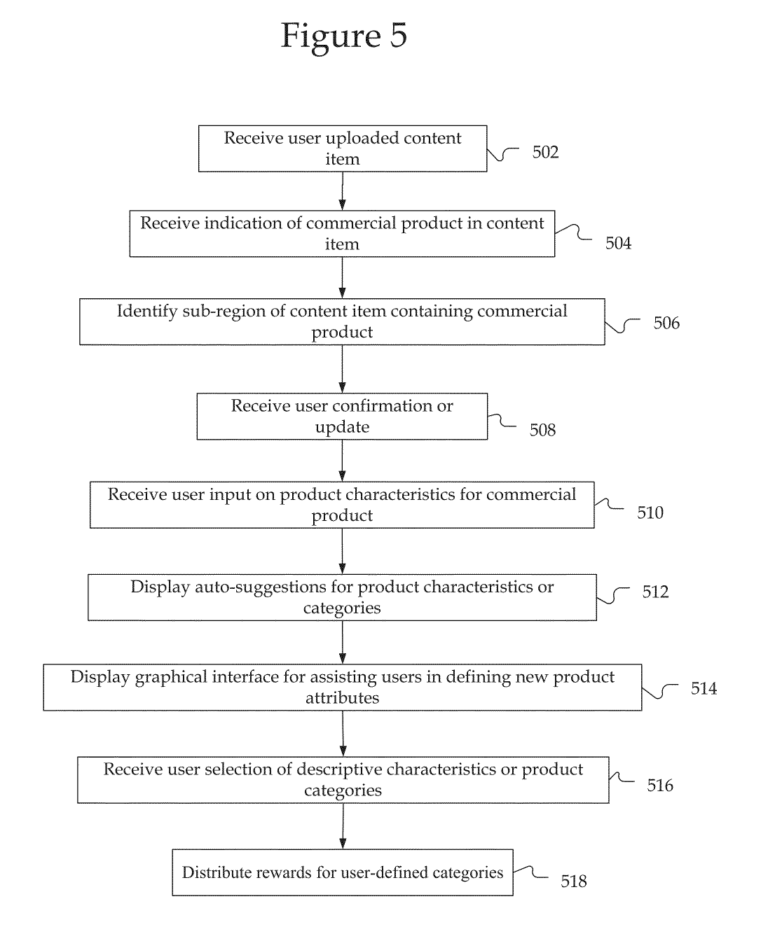

Referring now to FIG. 4, a flowchart illustrating an exemplary method for generating a feed of promoted commercial products according to one embodiment is shown. At block 402, data relating to a variety of commercial products is stored in one or more databases. Data may be gathered by the domain website itself through intermittent or real-time monitoring of web content, or may be retrieved from one or more third-party sources, such as through data injection or the use of crawlers. The stored data may span a variety of topics, including historical user behavior data, commercial product information, such as product characteristics, styles, brand names, manufacturer information, retail price, or suggested uses, and/or product data specifically created by users or moderators of the domain website.

At block 404, users interact with web content that may be hosted on either the domain website or third-party websites. The system monitors these interactions to generate behavioral data for the particular user or users of the website in general. The system monitors these interactions in order to dynamic inferences about users' social relationships as well as product relationships, such as an association between two or more commercial products or characteristics thereof. At block 406, the system can also receive commercial product data explicitly defined by a user. For example, in some embodiments, the user may upload a picture of a commercial product. Once uploaded, the user is able to provide details regarding the commercial product and to tag the photograph with any number of product characteristics. In other embodiments, the user may grant the system access to scan one or more photos located on the user's computer or on one of the user's social networking accounts that may be linked to the system. The user may specific a limited number of photographs to scan, or the system may scan only a limited subset of photographs, such as those that the system determines to be the most popular. For example, if the user has granted the system access to their social network, the system may consider the number of referral indicators, in addition to other data such as time stamps or geographic location, associated with the user's photographs in order to suggest a limited number of photographs for tagging. In this way, the system produces suggestions that are less overbearing to the user.

In either scenario, in order to generate high quality tags, the system uses an artificially intelligent algorithm to dynamically guide the user in selecting one or more suggested tags. Tags may be suggested to user not necessarily based on pseudo-random or computer generated text, but by analyzing prior tags created by users of the system in conjunction with behavioral data and stored commercial product data to determine which tags are most likely to be relevant to the commercial product. Additionally, the system can also allow the user to dynamically create tags that may not yet be entered into the system or that were not otherwise recommended. Various rewards schemes can be utilized to provide incentives to users for creating and choosing high-quality tags.

In accordance with at least one embodiment, the system may also automatically recognize various features within the content item in order to assist a user with tagging the content or to assist the recommendation module 306 in making product recommendations. For example, in the case where the content item is a photograph, the system may take into consideration where the user has placed the tag in the photograph. The system can then utilize aspects of the designated location of the photograph, such as shade, saturation, and contrast data, to automatically detect details about the item at that designated location. In this way, the system can automatically recognize, among other details, the color of the item being tagged, and can then consider this color in producing tag recommendations to the user.

Additionally, information that is automatically recognized by the system may be stored and aggregated to use in various system features. In the case of colors, for example, the system can store automatically recognized colors and aggregate them in order to build a style profile for the user. For example, the system may group colors based on common features or characteristics, such as color warmth or season application. Once this information is compiled and stored, the system can continually analyze the stored information to produce a series of parameters and ranges relating stylistic determinations between associated shades and color combinations. In some embodiments, the system may produce alerts or warnings to advise a user that particular color combinations fall outside optimal ranges. This warning can be used to indicate that two articles of clothing in an outfit do not match or go together. The system may also provide the user with an option to adjust the parameters and ranges of their particular style profile. It will also be apparent to those of ordinary skill in the art that additional product characteristics, such as brand or product price, can likewise be automatically recognized and stored to create similar user profiles and generate alerts when the products fall outside system-determined ranges.

Returning now to FIG. 4, at block 408, the system updates and augments the one or more databases storing the commercial product data with the additional data received from monitoring user interactions at block 404 and receiving user-defined at block 406. At block 410, a request is received to generate a feed of commercial products for a particular user. At block 412, the request is processed to retrieve relevant commercial product data from the databases. For example, in some embodiments, a new user may browse to the website and a general request for a feed of content may be automatically be submitted to the system. In other embodiments, even though the user has not visited the domain website before, the system may nevertheless read data from the user's cookies and other available behavioral data and use machine learning techniques to automatically predict which content may be best suited for that particular user. If the user has visited the domain website before and/or has created an account, the system can also retrieve historical data and preferences data for that user in order to generate a feed tailored to that user. In additional embodiments, the system may use machine learning techniques that consistently monitor not only the user but also other users sharing a common characteristic with the user in order to generate feeds that include trending products among other users that share a certain degree of connection with the user.

At block 414, the system can identify promoted and/or trending data with the system and provide ordered results. For example, in conjunction with reward schemes used in certain embodiments, the system may allow advertisers to bid on or otherwise pay a fee for preferential placement of their commercial products. Additionally, advertisers may pay fees to associate their products with those of a competitor or with certain keywords. In these embodiments, the advertiser's product may be inserted into a feeds meeting the targeting criteria specified in a particular advertising campaign, or may be displayed as part of an advertisements located elsewhere on the webpage, such as in banners along-side the feed.

At block 416, certain embodiments of the system may filter the retrieved commercial product feed according to privacy restrictions. For example, feeds may be filtered according to privacy restrictions set by either the user for which the feed is being generated, or the users that have uploaded and created commercial product data that is now being displayed in the feed. Thus, other users may restrict their user-created content or information related to their past system activity such that the content and activities are available only to a limited subset of system users, such as only to those users that share a certain degree of connection with the user. At block 418, certain embodiments may further filter the retrieved commercial product data according to historical user data for the particular user. The feed may be filtered according to network data relating to product performance or based on data analytics indicating that certain products are more or less relevant to the particular user. At block 420, the final feed of commercial product is generated and presented to the user. FIG. 7 depicts an exemplary graphical representation of a default content feed that may be generated using all or some of the steps of the method described in connection with FIG. 4.

Referring now to FIG. 5, a flowchart illustrating an exemplary method for identifying commercial products and receiving user-defined categories according to one embodiment is depicted. At block 502, the user uploads a content item to the system using the user interface. The content item may be located on the particular user device being used to access the system, such as a smartphone or laptop computer, or may be located elsewhere on the Internet, such as on a third-party website that is accessed by the user and submitted via a hyperlink to the content item. At block 504, the system receives an indication identifying a commercial product in the content item. The indication may be received via a user interface by a user clicking on the commercial product depicted within the content item, such as a photograph. At block 506, a sub-region of the content item containing the commercial product is identified by the system. For example, in the case where the content item is a picture, the system may identify a bounded region containing the commercial product based on the indication received from the user via the user interface. In additional embodiments, the system may analyze the pixel information in the picture in order to automatically generate a bounded region surrounding one or more commercial products in the photograph.

At block 508, the user interface may provide the user with a button or tool to confirm the accuracy of the bounded region generated by the system. The user can be provided with various techniques for updating or altering the bounded region in order that it more accurately reflects the dimension of the commercial product contained with the content item. For example, the user may drag and drop edges of the bounded region, or change and alter the portion identified during the user indication in block 504. Additionally, in some embodiments, the user may place a brand tag on the photo and move the tag a location near the item depicted in the photograph. The user may also drag and drop a leader line or other indicator to pinpoint the location of the relevant item in the photograph and provide a visual connector the brand tag. At block 510, the system receives user input on product characteristics for the commercial product. In certain embodiments, the user may be prompted to specify one or more mandatory and/or preferred product characteristics, such as product brand or manufacturer. Additionally, the user may be provided with incentives and rewards for specifying one or more additional preferred product characteristics.

At block 512, the system can provide auto-suggestions in order to assist the user in defining the commercial product characteristics. For example, certain embodiments may use machine learning techniques to determine which tags are best suited to the particular commercial product identified in the content item. The tags may be generated by the system itself by analyzing historical behavior for all users of the system, or the tags may have been explicitly created by other users and were determined by the system to be likely to have a high degree of association with the commercial product identified, as was further described above in connection with recommendation module 306. At block 514, a graphical interface may be displayed that assists users in defining new commercial product attributes and characteristics. In some embodiments, the user may be provided with a tree-like structure or flyout windows for guiding process for defining relevant tags. In other embodiments, a user may specify hashtags and receive system generated recommendations throughout the process. At block 516, the user selects one or more descriptive characteristics or product categories recommended by the system. At block 518, after the user has finished defining or selecting all of the desired product characteristics, the system will distribute the rewards corresponding to the quality and number of tags provided by the user.

In certain embodiments, the user maybe accessing the system from a mobile browser or smartphone application that implements the user interface. In this instance, the user may also be able to utilize the mobile device's camera in order to take a picture of a commercial product's barcode. The mobile application interface will automatically search the product database to identify commercial product associated with the barcode. The user will then be able to proceed with defining the product tags as described in connection with FIG. 5.

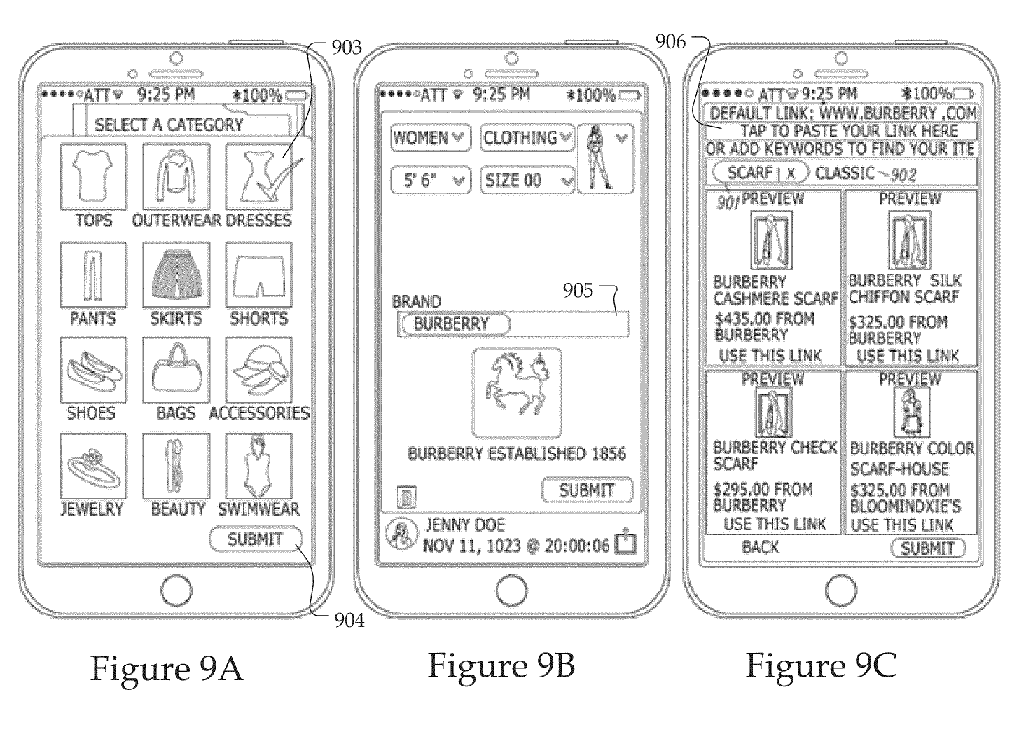

Referring now to FIG. 8, an exemplary graphical representation of a user interface for assisting a user in identifying characteristics and categories of commercial products according to one embodiment is depicted. In this embodiment, after the user uploads content item 801, user interface 800 is displayed to the user. The content item 801 is displayed alongside a list of tags 802 that have been previously been defined for one or more commercial products depicted in the content item 801. An additional window 803 is provided for assisting the user in tagging content item 801 with additional tags, as well as for allowing the user to dynamically define additional tags relating to the characteristics of the commercial product identified in content item 801. As the user begins to enter information into a field box of window 803, the system may auto-generate a list 806 of suggested tags. The tags may be displayed alongside one or more reward indicators 807 that provide incentives for the user to specify additional, high-quality tags. The user may first be required to specify a mandatory or preferred tag, such as manufacturer tag 804. Additionally, the user may add additional tags, such as fabric type 805 or other product characteristics.

User interface window 803 may also provide the user with hyperlink entry box 808 to allow the user to link the commercial product directly to a third-party website, such as a manufacturer or retailer of the item. The system may also automatically generate list 810 commercial products potentially matching one or more products identified in the content item. The list 810 may be generated based on an analysis of the data stored in the systems databases, or may be generated from a set of products submitted by one or more manufacturers or retailers by matching the tags to specific targeting criteria provided by those third-party businesses. Once the list 810 is generated, the user may then select the corresponding item to directly link the commercial product with the third-party website.

Once the user has added all of the desired tags, as well as any narrative product description or comments on the content item, the user may click interface button 811 to add the tag to the content item and eventually submit the content item for use on the domain website. Additionally, the user interface may provide the user with one or more quick-share boxes 812 that can be selected before submitting the content item. Quick-share boxes 812 may allow a user to simultaneously share the content item on one or more social networks that have been linked the user's account via public APIs. Additionally, quick-share boxes 812 may allow the user to share the content item directly to one or more forums or libraries that the user has been granted access rights to on the system itself. The graphical representation provided in FIG. 8 is merely an exemplary implementation in accordance various embodiments disclosed herein and it will be apparent to those of ordinary skill in the art that many more features, alterations, or implementations are possible within the scope of the invention.

Referring now to FIGS. 9A-9E, exemplary graphical representations of mobile user interfaces for generating user-defined defining commercial product categories and characteristics according to an additional embodiment is depicted. As depicted in FIG. 9A, in these embodiments, the system first displays a graphical list of categories of content items to the user such that the user may select the appropriate category associated with the commercial product from the list. The list may include any number of categories that may be associated with commercial products in general and which may be advantageously defined in order to facilitate a user's quick and efficient identification of the commercial product. In this example, the industry is fashion-based and the list includes tops, outerwear, dresses, pants, skirts, shorts, shoes, bags, accessories, jewelry, beauty, and swimwear. The user may select a category by tapping or otherwise interacting with the display, such as by selected dresses category 903. Once selected, the user may optionally interact with an interface element to proceed to the next display screen, such as submit button 904. Once the category is selected, the system displays a graphical user interface, such as depicted in FIG. 9B, that allows the user to enter further identifying characteristics associated with the commercial, such as the gender the product is designed for, the clothing type, the user's height, and/or size. The user is further provided with a text field 905 that allows the user to enter in brand or manufacturer identifying data as tagged information to ultimately be associated with the commercial product. As the user enters information, the system may again auto-generate a list of suggested brand names that may be generated from the database of commercial products stored by the system or received from one or more third party databases or data feeds.

Next, the system displays a list of commercial products associated with the identified brand or manufacturer. In some embodiments, the list may be displayed as a graphical list of products including thumbnail images and text associated with commercial products as depicted in FIG. 9C. In this embodiment, the user is again provided with a text field box 901, which the user may begin to enter commercial product information. As the user enters information, the system may again auto-generate a list 902 of suggested tags. The interface in this embodiment allows the user to select any of these tags as matched descriptions for the product or to dynamically enter and define new tags. In the depicted embodiment, the user is supplied with recommendations in the form of graphical button elements that may be dynamically created and deleted, although other methods may be used, such as hash tags and the like. For example, in some embodiments, the system provides a way for guiding the user through a step-by-step process in which the user may dynamically define tags through a series of prompts, such as by a tree-like structure of hierarchical logic where the user is prompted to identify broad product characteristics at first but the prompts gradually become more refined as a user selects one or more parameters. In addition to a tree structure, it should apparent to those of ordinary skill in that art that additional techniques may be provided to guide a user in dynamically defining product tags, such as flyout windows, nested menu bars, and the like. By allowing a user to dynamically define content, the system may assist a user in defining high quality tags for commercial items, while simultaneously generating and preserving the relationship data for use in the system's machine learning algorithms. In this way, the use of the system to define product tags contributes to high-quality data generation and the development of a database of robust commercial product data. Moreover, such data can be further optimized based on monitoring user interaction with computer-generated content and suggestions, in order to infer user feedback on the quality of the system recommendations. As the user, selects enters tag information or selects one of the tags suggested by the system, the system automatically refines the list of displayed content items such that only content items sharing the user-defined tag are displayed. In this way, the user is able to narrow down the displayed commercial products and to identify the particular commercial product displayed in their photograph. Similarly, the system may also provide the user with a text field 906 which the user may enter a link directly to the commercial product that may be displayed a third-party website. By doing so, the system can facilitate the linking of the user-defined tags with the content items in order to provide financial incentives for identifying content items and contributing to referral indicators for the commercial products, as described in connection with FIG. 9E for example.

One the user has selected the correct commercial product information that was displayed as described in connection with FIG. 9C, the system may present the user with a summary of the identified characteristics associated with the content item as shown in FIG. 9D. For example, the system may identify one or more retailers 907 associated with the content item where commercial product may be purchased. The graphical representation 907 of this retailer may include a hyperlink to the retailer's website and may utilize deep linking to track interactions with the third-party website that originate from the display provided by the system. The system may also display the category 908 selected by the user, the user features 910 defined by the user, the commercial product information 909 retrieved from the system database or one or more third-party websites or data feeds, and/or a list 911 of content items that are determined to be similar to the selected content item. Once the user confirms that the displayed information is accurate, the user system may display the user's photograph along with the tagged information as shown in FIG. 9E, for example. In this embodiment, the photograph 912 uploaded or selected by the user is displayed. The tagged information is displayed in a graphical element 913 that may contain the identified brand or manufacturer information. The graphical element 913 may contain a component 914 that allows the user to like or save the content item identified in the photograph. Additionally, when generating the tagged information, the system may allow the user to drag and drop the display element 913 to any location on the screen so as not to block the tagged commercial product. In some embodiments, the user may similarly adjust a leader line that connects the tagged information with the commercial product displayed in the photograph. Additionally, the system may display number of referral indicators 915 whenever the tagged commercial product is displayed. The referral indicators may indicate, for example, how many times the content item has been shared and/or liked on various social networking sites, or how many users of the system have liked or saved the content item to their own feed.

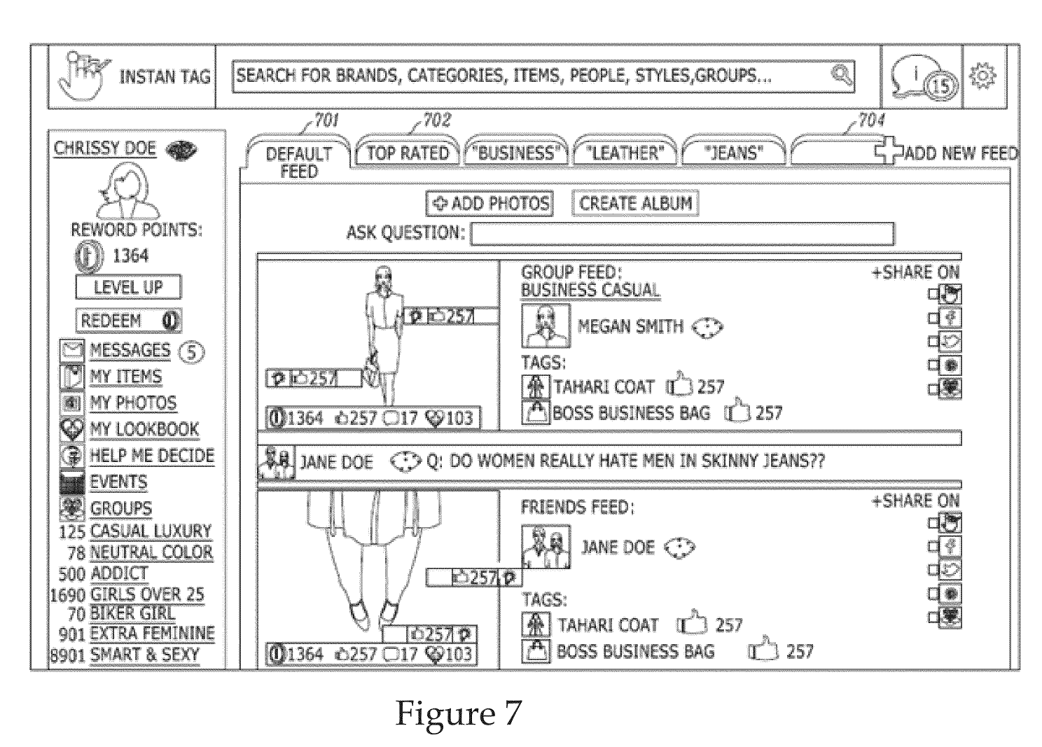

Referring now to FIG. 6, a flowchart illustrating an exemplary method for generating and conducting polls or surveys according to one embodiment is depicted. At block 602, the system may receive a user indication of a poll topic or product attribute that is of interest to the user. For example, a user may create a poll or survey to address a specific question with respect to one or more commercial products, or may opt to specify a poll topic relating to set of commercial product characteristics that are of interest to the user. Manufactures or retailers may also use polls and surveys to, for example, assist in forecasting product demand. Additionally, the system itself may generate a poll on its own without a user or manufacturer having to create the poll. The system may use machine learning techniques to analyze user interaction with system content in order to generate polls that are displayed to all users, or targeted to a subset of users based a set of targeting criteria. Targeting criteria may be generated by system administrators or may be generated by the system's analysis of the commercial product and historical behavior data stored in its databases.

At block 604, the user, or system as the case may be, can define the operating parameters for a particular poll. For example, user may define a certain run-time for the poll, or set particular criteria for user participation (e.g., that all users answers to the poll must be contain a particular product characteristic). At block 606, the user may finalize the poll and post the poll to others users within the social network. The creating user may optionally specify privacy restrictions on the poll or survey, such that it is displayed to only a subset of the user's private network. At block 608, while the poll is running, the system may automatically provide recommended answers to other users that view the poll, such as based on the operating parameters specified by the poll creator or based on an analysis of historical user behavior data. At block 610, other users with the creator's networks can participate in the poll by providing input and recommending answers that meet the operating parameters defined by the creator. At block 612, the creator can select a winning response, and at block 614, the system can distribute rewards to the users that participated in the poll.

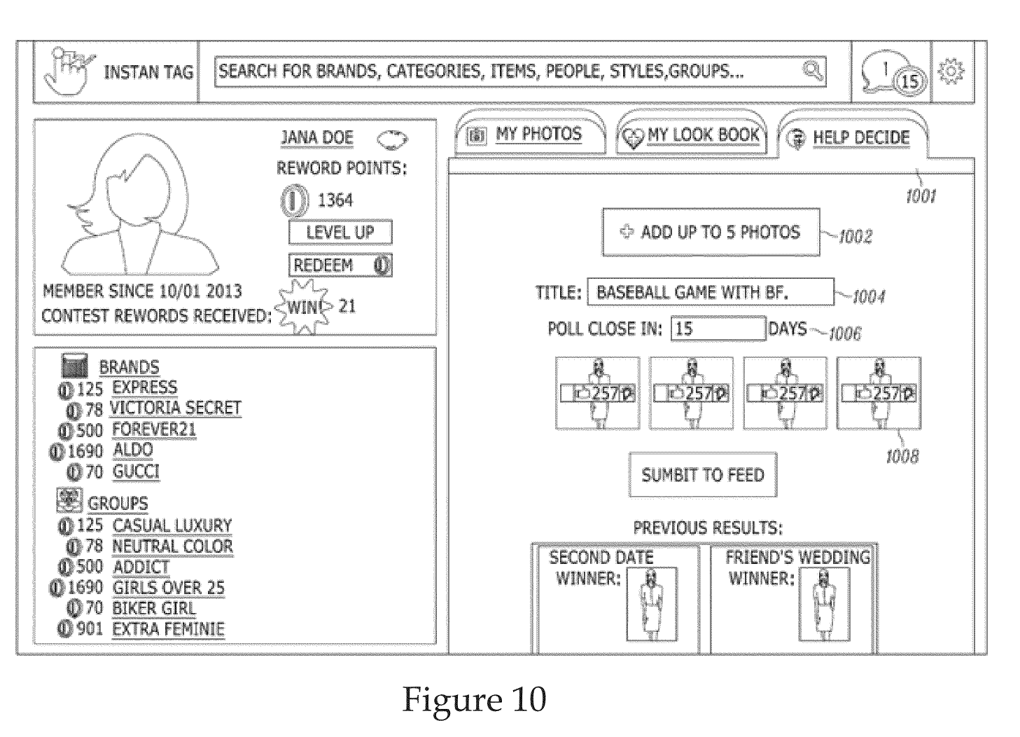

In addition to uploading content items, defining tags, and creating surveys or polls, it also an aim of the system to provide users with a number social networking and social interaction tools in order to facilitate user participation. For example, ways of using rewards to foster participation in generating commercial product data have been described. Additionally, the system may also advantageously provide the users with access to various social networking features and optionally associate reward schemes with each, such as forums, discussion boards, chat features, public and private albums, such as topic-based albums, with varying level of user access restrictions, or other social networking advice tools. For example, the system can implement fashion advice tools such as the “Help Decide” or “Friends Haven't Seen” features discussed in connection with FIG. 10, assist users in generating “LookBooks” or albums with products tailored to a specific category or topic. It should apparent to those of ordinary skill in that art that the illustrations of social networking features in the figures and those described herein are merely exemplary and additional techniques may be provided in accordance with the spirit of the invention in order to promote user participation with the system and generation of high-quality, commercial product data.

Referring now to FIG. 10, an exemplary graphical representation of a user interface for defining a fashion advice poll using the Help Decide feature, is depicted according to one embodiment. Fashion polls and other features like Help Decide allow system users to advantageously make use of the commercial product data aggregated by the back-end system to receive product recommendations. For example, the system may implement a number of product suggestion features that allow a particular use to receive input from fellow users as well as directly from the system itself through automatically generated input on product recommendations, fashion trends, topic-based matching advice, purchasing suggestions, and so forth. As illustrated by the embodiment depicted in FIG. 10, a user may access the Help Decide tab 1001 and create a fashion advice poll related to a topic of interest. The user may enter the descriptive title in box 1004, as well as specify operating parameters for the poll, such as specifying a number of days the poll runs in box 1006. Although not depicted, in additional embodiments the user may use one or more menus or text fields to specify descriptive characteristics of the product that the user is seeking advice for. For example, the user may limit the responses to the survey to products having a particular characteristic. In some embodiments, the user may add one or more photos using photo button 1002 to be considered by other users that provide responses to the poll.

Once a user has submitted the poll for consideration, the poll can then be displayed to other users with the user's social network, or a subset of users thereof that have been granted access to the poll. Other users viewing may then provide one or more commercial products that match the topic of interest or otherwise answer the poll. For example, other users may select from one of or more of the photographs added during creation of the poll. Additionally, users may be able to browse feeds of commercial products to select one that may be relevant to the poll. In additional embodiments, the system itself may process historical user behavior data and the specified product characteristics in order to recommend related, trending, or popular similar items that may serve as answers to the poll. Once the period set for poll operation has lapsed, the creating user may view answers submitted by other users and select the winning response. The system may then distribute awards according to the users that submitted the selected or “winning” response.

In a similar manner, although not depicted, the system may also implement a Friends Haven't Seen feature that considers product data worldwide, or within a specific region, and presents the user with popular items that the user and/or their friends may be unlikely to have interacted with or viewed. For example, in one embodiment a user may utilize the Friends Haven't Seen feature to be presented with product recommendations that have not been displayed to or viewed by users within their social network. Additionally, the system may further consider the degrees of connection between various system users, as well as other previously described targeting criteria where appropriate, to filter the product data displayed by Friends Haven't Seen and to exclude only items that which have received a certain level of exposure to the other members of the user's social network. In this way, the system may not only provide top picks and suggestions for a user based on trending data within a user's social network, but also takes a reverse approach to consider product data that may, for example, have low trending ratings within the user's particular social network, but has become popular in other geographic regions or social circles.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

In addition, the system described herein may utilize the services of one or more third-party search engines to retrieve commercial product data. A search engine may enable a device, such as a client device or a system crawler, to search for files of interest using a search query. Typically, a search engine may be accessed by a client device or crawler via one or more servers. In some embodiments, the present system may utilize access to a search engine, such as by a crawler or user device, to retrieve information related to one or more commercial products. Additionally, the system utilizes data stored in cookies, or by other browsing data storage techniques, to retrieve commercial product information that may relevant to the interests of the particular user.

A web crawler may be described as a computer program configured to obtain web content for use by the search engines using information about web content as provided by its address or URL, metadata, and other criteria found within the web content itself. A web crawler is run periodically to update previously stored data. A web crawler may be viewed as a crawler module (that generates work items—URLs that should be accessed) and a fetcher module (that obtains work items generated by the crawler module and retrieves web content based on the URLs associated with the work items). A crawler may be operable to communicate with a variety of content servers, typically via network. While visiting URLs, the crawler may identify additional URLs at that web page and add them to a list of URLs to visit or “crawl.” A crawler may retrieve files and web content from a plurality of content servers as it “crawls” across a network.

Various embodiments may also use an indexer component to generate an index of commercial product data, including associated contextual content, such as for one or more databases, which may be searched to locate content, including contextual content. In some embodiments, a shared weight index may be utilized to optimize a database query. In addition, in some embodiments, an index associated with the column from a database table is created, where the index is configured with a shared weight attribute. The shared weight index is created based upon the index. Some embodiments generate a sort sequence table associated with the shared weight index, where the shared weight index includes a plurality of entries and the sort sequence table includes a value correlation for each entry of the shared weight index. In these embodiments, the value correlation may be associated with a location offset of the shared weight index. Additionally, a weight map associated with the sort sequence table may be generated where the weight map may include a weight correlation for each entry in the sort sequence table. Certain embodiments may utilize one or more of the shared weight index, weight map, and/or sort sequence table in order to perform query optimization based on associated weights.

Various embodiments may make use of a Boolean style search engine when searching on or more of the indices to retrieve commercial product data, using connectors such as AND, OR, NOT, or XOR to specify a logical relationship between search terms. In contrast to Boolean-style syntax, embodiments may also utilize a semantic search feature when searching on or more of the indices to retrieve commercial product data. “Semantic search” refers a search technique in which search results are evaluated for relevance based at least in part on contextual meaning associated with query search terms. In contrast with Boolean-style syntax to specify a relationship between search terms, a semantic search may attempt to infer a meaning for terms of a natural language search query.

Search results located during a search of an index performed in response to a search query submission may typically be ranked. An index may include entries with an index entry assigned a value referred to as a weight. A search query may comprise search query terms, wherein a query term may correspond to an index entry. In an embodiment, search results may be ranked by scoring located files or records, for example, such as in accordance with number of times a query term occurs weighed in accordance with a weight assigned to an index entry corresponding to the query term. Other aspects may also affect ranking, such as, for example, proximity of query terms within a located record or file, or semantic usage, for example. A score and an identifier for a located record or file, for example, may be stored in a respective entry of a ranking list. A list of search results may be ranked in accordance with scores, which may, for example, be provided in response to a search query. In some embodiments, machine-learned ranking (MLR) models are used to rank search results. MLR is a type of supervised or semi-supervised machine learning problem with the goal to automatically construct a ranking model from training data.

In one embodiment, as an individual interacts with a software application, e.g., an instant messenger or electronic mail application, descriptive content, such in the form of signals or stored physical states within memory, such as, for example, an email address, instant messenger identifier, phone number, postal address, message content, date, time, etc., may be identified. Descriptive content may be stored, typically along with contextual content. Contextual content, therefore, may identify circumstances surrounding interaction with web content by user devices (e.g., date or time or browser completing the action) and may be associated with descriptive content. Contextual content, may, for example, be used to subsequently search for associated descriptive content.

A profile builder may initiate generation of a profile, such for users of an individual application or users that have created an account with the system, for example. A profile builder may initiate generation of a user profile for use, for example, by a user, as well as by an entity that may have provided the individual application utilized by the user. For example, a profile builder may enhance relevance determinations and thereby assist in indexing, searching or ranking search results in response to a user query. Therefore, various embodiments may employ a profile builder to enhance search results on returned by system and to optimize the results for a particular user. Additionally, a profile builder may be used to provide custom content for a user, such as in that user's feeds or other pages. A variety of mechanisms may be implemented to generate a profile including, but not limited to, collecting or mining navigation history, stored documents, tags, or annotations, to provide a few examples. A profile builder may store a generated profile. Profiles of users may give the system a mechanism to retrieve annotations, tags, stored pages, navigation history, or the like, which may be useful for making relevance determinations of search results and feeds, such as with respect to a particular user.

Advertising may include sponsored search advertising, non-sponsored search advertising, guaranteed and non-guaranteed delivery advertising, ad networks/exchanges, ad targeting, ad serving, and/or ad analytics. Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like the domain provided in accordance with present description, advertisements may be displayed on web pages resulting from a user-defined search for commercial products or on a feed generated and provided to a user in the course of using the domain. Advertising may be beneficial to users, advertisers, and the domain if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

While the computer-readable medium as described or set forth in the appended claim may be described as a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

Note that dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for identifying and promoting tagged commercial products, the system comprising:
a database configured to store product information for a plurality of commercial products;
an interface module configured to receive submission of a content item containing one or more commercial products and identification information identifying a product characteristic of at least one of the commercial products,
wherein the interface module is further configured to store the identification information in the database; and
a recommendation module configured process the identification information and to retrieve a subset of product information from the database using at least the product characteristic of the at least one commercial product; and
a website module configured to generate display logic for displaying the subset of the product information on a user interface.

2. The system of claim 1, wherein the interface module is further configured to allow a user to dynamically generate the identification information.

3. The system of claim 1, wherein the recommendation module is further configured to process the stored product information to generate recommended identification information that is displayed to by the user interface after submission of the content item.

4. The system of claim 1, wherein the recommendation module is further configured to process the identification information using historical behavioral data of a user to generate a tailored subset of product information.

5. The system of claim 4, wherein the website module is configured to display the tailored subset of product information as a feed to the user.

6. The system of claim 1, further comprising an online query module configured to receive a request identifying one or more categories of commercial products.

7. The system of claim 6, wherein the recommendation module is further configured to process the request identifying one or more categories of commercial products in order to retrieve product information from the database sharing a common product characteristic with at least one category identified by the request.

8. The system of claim 1, further comprising an advertisement display module configured to select an advertisement using at least the identification information received by interface module and to display the advertisement on the user interface.

9. The system of claim 1, wherein the product characteristic of the at least one commercial product comprises a brand, a manufacturer, or a retailer of the product identified in the digital photograph.

10. The system of claim 1, wherein the product characteristic of the at least one commercial product comprises a clothing style, a fashion, or suggested use of the product identified in the digital photograph.

11. The system of claim 1, further comprising a rewards module configured to monitor user interactions with product information displayed on the user interface and to distribute rewards based on the user interactions.

12. A non-transitory computer readable medium having stored therein data representing instructions executable by a programmed processor for identifying and recommending tagged commercial products, the storage medium comprising instructions operative for:
storing commercial product data defining one or more product characteristics of a plurality of commercial products to a database;
receiving a submission of a content item and an indication identifying a commercial product contained in the content item;
processing the stored commercial product data to generate a plurality of recommended tags describing potential product characteristics of the identified commercial product;
receiving a selection of at least one of the plurality of recommended tags, the selection signifying an association of the recommended tag and the identified commercial product; and
updating the stored commercial product data with data representing the association of the recommended tag and the identified commercial product.

13. The storage medium of claim 12, further comprising instructions operative for storing user behavior data defining one or more user interactions with web content.

14. The storage medium of claim 13, further comprising instructions operative for receiving a request for a category of commercial products and processing the request to identify a subset of the stored commercial product data relating to the requested category.

15. The storage medium of claim 14, further comprising instructions operative for generating and displaying a feed of the subset of stored commercial product data to a user interface.

16. A computer-implemented method for identifying and promoting commercial tagged products, the method comprising:
storing commercial product information to a database;
providing a user interface that allows a user to upload a content item containing one or more commercial products;
receiving an identification of one or more commercial products in the content item from the user;
processing the stored commercial product information to update the user interface to dynamically guide the user in defining one or more tags associated with a commercial product contained in the content item; and
updating the stored commercial product information with the defined one or more tags associated with the commercial product.

17. The computer-implemented method of claim 16, further comprising receiving a requested category of commercial products.

18. The computer-implemented method of claim 17, further comprising processing the requested category of commercial products to identify stored commercial product information sharing a common product characteristic with the requested category.

19. The computer-implemented method of claim 18, further comprising generating a feed of recommended commercial products to display to the user via the user interface.

20. The computer-implemented method of claim 19, wherein the generated feed of recommended commercial products is optimized using historical user behavior data or social networking performance data.
